(19) United States
(12) Patent Application Publication
(10) Pub. No.: US 2006/0200509 A1
(43) Pub. Date: Sep. 7, 2006

(54) Method and apparatus for addressing media resource, and recording medium thereof

(76) Inventors: Yong Ju Cho, Seoul (KR); Jin-Woo Hong, Daejeon-city (KR); Jin-Woong Kim, Daejeon-city (KR)

Correspondence Address: LADAS & PARRY LLP, 224 SOUTH MICHIGAN AVENUE, SUITE 1600, CHICAGO, IL, 60604, US

(21) Appl. No.: 10/564,771

(22) PCT Filed: Jul. 14, 2004
(86) PCT No.: PCT/KR04/01746

§ 371 Date: Mar. 14, 2006

(30) Foreign Application Priority Data
Jul. 15, 2003 (KR) 10-2003-0048290
Oct. 14, 2003 (KR) 10-2003-0071590

(51) Int. Cl. G06F 17/30

(52) U.S. Cl. 707/205

(57) ABSTRACT

Disclosed are a media resource addressing method and a recording medium thereof. The media resource addressing method for a media file which includes a meta data box including a DID and a media data box, comprises extracting a corresponding media resource according to reference information of the media resource recorded in the DID; storing the extracted media resource in the media data box; generating standard location information of the media resource; storing the generated standard location information in the meta data box, and filing the meta data box and the media data box.

### TECHNICAL FIELD

The present invention relates to a media resource addressing method and device. More specifically, the present invention relates to a media resource addressing method and device in the MPEG (motion picture experts group)-21 format.

### BACKGROUND ART

The MPEG-21 belongs to one of MPEG divisions, and aims at building distribution frameworks for establishing an infrastructure for effective transmission and distribution of multimedia information in different dispersed systems on the Internet, and also aims at founding various essential techniques and developing related technical standards.

The DID based on the ISO media file format and basic structures for storing media contents have been proposed for the WD1.1 in the MPEG-21 file format, but no detailed methods for addressing media resources in the DID have been disclosed.

### DISCLOSURE

### TECHNICAL PROBLEM

It is an advantage of the present invention to provide a media resource addressing method and device in the MPEG-21 file format.

It is another advantage of the present invention to provide a media resource addressing method and device for providing compatibility between MPEG-21 files and MPEG-4 files in the ISO media file format.

### TECHNICAL SOLUTION

In one aspect of the present invention, in a method for addressing a media resource for a media file including a meta data box including a DID (digital item declaration) and a media data box, a media resource addressing method comprises: extracting a corresponding media resource according to reference information of the media resource recorded in the DID; storing the extracted media resource in the media data box; generating standard location information of the media resource; storing the generated standard location information in the meta data box; and filing the meta data box and the media data box.

The standard location Information of the media resource is generated by using an offset value of the media data box storing the media resource.

The standard location information is generated by using an offset value of an MPEG (motion picture experts group)-4 file stored in the media data box and location information of the media resource of the MPEG-4 file when the media resource is provided in the MPEG-4 file.

Location information of the media resource provided in the MPEG-4 file is a track value provided in the meta data box of the MPEG-4 file.

Location information of the media resource provided in the MPEG-4 file includes an ODID (object descriptor ID) and an ESID (elementary stream ID) of the media resource.

The meta date box further comprises a local item region, and the standard location information is stored in the local item region.

The media file is an MPEG-21 file.

In another aspect of the present invention, in a method for addressing a media resource for a meta data box including a DID (digital item declaration) and a media file including a media data box, a media resource addressing method comprises: reading reference information of a media resource recorded in the DID; reading reference information of the media resource of a second media file when the media resource is provided in the second media file; using the reference information of the media resource and the reference information of the second media file, and generating standard location information; storing the standard location information in the meta data box; and filing the meta data box.

In still another aspect of the present invention, in a media resource addressing device for an MPEG-21 file including a meta data box including a DID and a media data box, a media resource addressing device comprises: a DID reader for reading reference information of the media resource recorded in the DID, determining whether the DID refers to the media resource in the file or out of the file, and outputting the reference information of the media resource when the DID refers to the media resource in the file; a media resource extractor for extracting the media resource according to the reference information output by the DID reader, and storing the media resource in the media data box; a standard location generator for generating standard location information of the media resource, and storing the standard location information in the meta data box; and a filing unit for filing the meta data box and the media data box into a single file.

In still yet another aspect of the present invention, in a recording medium for writing a media resource addressing program of an MPEG-21 file including a meta data box including a DID (digital item declaration) and a media data box, a media resource addressing program writable on a recording medium comprises: reading media resource reference information recorded in the DID; extracting the media resource, storing the extracted media resource in the media data box, using an offset value of the media data box storing the media resource, and generating standard location information of the media resource when the DID refers to the media resource in the file; and using location information of the media resource, and generating standard location information of the media resource when the DID refers to the media resource out of the file.

### ADVANTAGEOUS EFFECT

According to the present invention, location information of media resources are standardized in the MPEG-21 file format, and effective access and reproduction on the media resources is allowed. Further, the media resources are addressed in order to support compatibility between the MPEG-21 files and the MPEG-4 files in the ISO media file format.

### DESCRIPTION OF DRAWINGS

The accompanying drawings, which are incorporated in and constitute a part of the specification, illustrate an embodiment of the invention, and, together with the description, serve to explain the principles of the invention;

FIG. 1 shows a conceptual diagram of the WD1.1-based ISO media file format;

FIG. 2 shows a media resource addressing device according to a preferred embodiment of the present invention;

FIG. 3 shows a flowchart for a media resource addressing method according to a first preferred embodiment of the present invention; and

FIG. 4 shows a flowchart for a media resource addressing method according to a second preferred embodiment of the present invention.

### BEST MODE

In the following detailed description, only the preferred embodiment of the invention has been shown and described, simply by way of illustration of the best mode contemplated by the inventor(s) of carrying out the invention. As will be realized, the invention is capable of modification in various obvious respects, all without departing from the invention. Accordingly, the drawings and description are to be regarded as illustrative in nature, and not restrictive. To clarify the present invention, parts which are not described in the specification are omitted, and parts for which similar descriptions are provided have the same reference numerals.

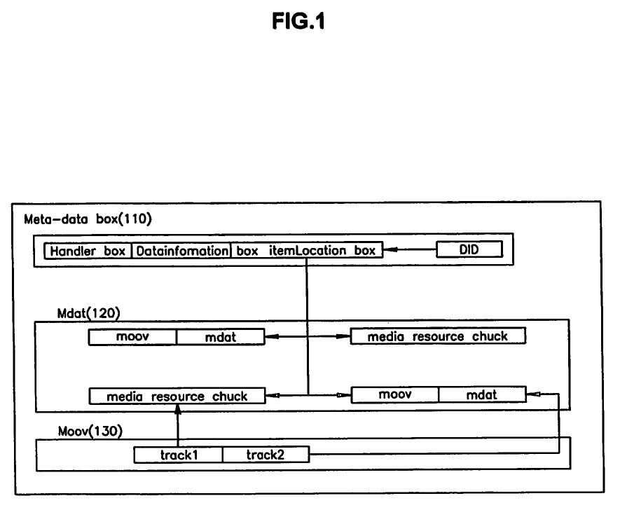

FIG. 1 shows a conceptual diagram of the WD1.1-based ISO media file format. The ISO media file format shown in FIG. 1 compatibly supports MPEG-4 files as well as MPEG-21 files, and comprises a meta data box (meta-data box: 110) of the MPEG-21 file, a media data box (mdat: 120), and a meta data box (moov: 130) of the MPEG-4 file.

The MPEG-21 file format comprises the meta data region 110 and the media data region 120, and the MPEG-4 file format comprises the meta data region 130 and the media data region 120.

The meta data region 110 of the MPEG-21 file format comprises a DID, a handler box, a data information box, and an item location box. The DID represents an xml-based text document, and comprises reference values of media resources. The handler box indicates a meta data type, and the data information box stores reference information of external media data. Also, the item location box comprises standard location information of media resources in/out of the file, and allows access to the media resources.

The media data box 120 stores various media resources including audio, video, and JPEG files. In particular, the media data box 120 stores MPEG-4 file format data in the case of MPEG-21 file format, as shown in FIG. 1.

Detailed configurations and functions of the meta data region 130 of the MPEG-4 file are described in the MPEG-4 system (14496-1). The meta data region 130 of the MPEG-4 file can be represented by a set of tracks each of which includes media which have information of the media resources. Therefore, it is possible to access the media resource in the media data box 120 by using track information.

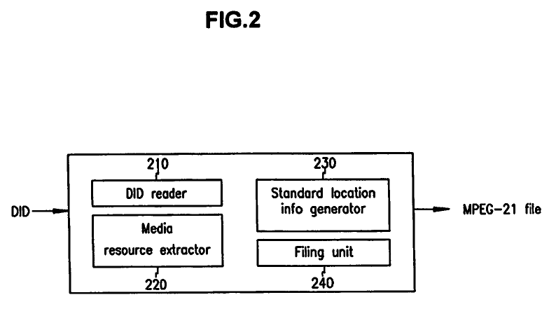

FIG. 2 shows a media resource addressing device according to a preferred embodiment of the present invention.

As shown in FIG. 2, the media resource addressing device comprises a DID reader 210, a media resource extractor 220, a standard location information generator 230, and a filing unit 240.

The DID reader 210 reads an input DID to determine whether the DID refers to the media resource in or out of the file, and transmits reference information of the media resource to the media resource extractor 220 when the DID refers to it in the file.

The media resource extractor 220 extracts the media resource according to the reference information of the media resource, and stores it in the media data box 120.

The standard location information generator 230 generates standard location information of the media resource and stores it in the meta data region 110, and the filing unit 230 files the meta data region 110 and the media data box 120 to thus generate a MPEG-21 file.

A media resource addressing method according to the preferred embodiment of the present invention will be described.

Different addressing methods are applied to the case of referring to the media resource within the file and the case of referring to the same out of the file, respectively. Hence, the media resource addressing method in the case of referring to the media resource within the file will be described as a first preferred embodiment, and the media resource addressing method in the case of referring to the media resource out of the file will be described as a second preferred embodiment.

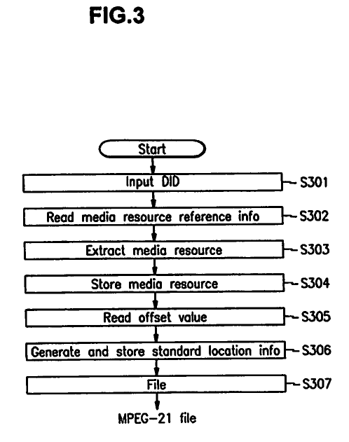

FIG. 3 shows a flowchart for a media resource addressing method according to a first preferred embodiment of the present invention.

As shown, the media resource addressing method according to the first preferred embodiment comprises: inputting a DID in step S301, reading media resource reference information in step S302, extracting a media resource in step S303, storing the media resource in step S304, reading an offset value in step S305, generating and storing standard location information in step 8306, and filing in step S307.

In detail, when a DID is input in step S301, the DID reader 210 reads the DID and extracts media resource reference information (Resource ref) in step S302. The media resource extractor 220 extracts the media resource by using the media resource reference information (Resource ref) in step S303.

That is, when the subsequent reference information is recorded in the DID, the media resource extractor 220 extracts a video file of test.mp4 from the hard disk drive C, and stores the video file in the media data box 120 in step S304.
<Resource ref=“c:\test.mp4” mimeType=“video/mp4”>

The media resource extractor 220 generates an offset value of the media data box 120 storing the media resource in step S305, generates standard location information, and stores the standard location information in the meta data box 110 in step S306. In this instance, the offset value represents a location at which the extracted media resource is stored in the media data box 120, and when the respective media resources are sequentially stored in the media data box 120, the offset value of the media resource to be stored next time is determined according to sizes of the stored respective resources.

The standard location information can be stored at a predetermined location of the meta data box 110, in particular, at an item location region of the meta data box 110.

When the filing process is performed in step S307, the meta data box 110 and the media data box 120 are formed to be an MPEG-21 file.

A method for generating standard location information according to the first embodiment of the present invention will be described.

Standard location information on the media resources including general video files, audio files, and JPEG files is generated by using the offset values as follows.
<Resource target=“offset=1000” mimeType=“video/mp4”>

When the media resource provided in the file is an MPEG-4 file, the standard location Information is generated by using a track value provided in the meta data box 130 of the MPEG-4 file.

<Resource target=“#offset=1000/moov/trak[1]”
mimeType=“video/mp4”>

The standard location information represents an ES (elementary stream) of a video type indicated by the first track from among the meta data box 130 of the MPEG-4 file, and is accessible to the MPEG-4 file and reproducible by the location information.

Also, when the media resource is an MPEG-4 file, it can be shown that the file to be referred to has an MPEG-4 file format by deleting the moov 130 included between the offset value and the track value and adding a special symbols of ‘/’.

<Resource target=“#offset=1000//trak[1]”
mimeType=“video/mp4”>

Further, when attempting to refer to an ES having a specific ODID and an ESID within the MPEG-4 file, the standard location information can be addressed by combination of the offset value, the ODID, and the ESID as below.
<Resource target=“#offset=1000:odid=0x10&esid=0x11”>

That is, when the value of ODID is 0x10 and the value of ESID is 0x11, the addressing possible by using the offset value and the values of the ODID and the ESID of the MPEG-4 file.

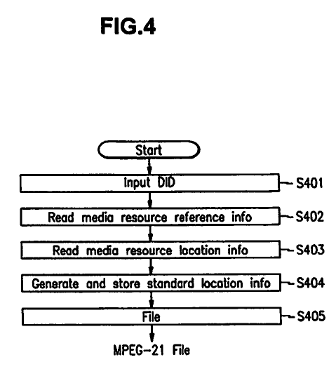

FIG. 4 shows a flowchart for a media resource addressing method according to a second preferred embodiment of the present invention.

The media resource addressing method when the media resource is referred to out of the file according to the second preferred embodiment comprises: inputting a DID in step S401, reading media resource reference information in step S402, determining whether the media resource is an MPEG-4 file in step S403, extracting location information of the MPEG-4 file in step S404, generating standard location information in step S405, and filing in step S406.

In detail, when a DID is input in step S401, the DID reader 210 reads reference information (Resource ref) of the media resource in step S402, and extracts URL information at which the media resource is provided.

The DID reader 210 reads location information of the media resource to be referred to in step S403. That is, the DID reader 210 extracts track information of the meta data box 130, the ESID, or the OSID when the media resource is provided in the MPEG-4 file, and extracts an offset value at which the media resource is provided when the media resource is an MPEG-21 file.

The standard location information generator 230 uses the extracted information to generate standard location information, and stores it in the meta data box 110 in step S404. The filing unit 240 files the meta data box in step S405 and generates an MPEG-21 file on which standard location information is recorded.

A standard location information generation method according to a second preferred embodiment of the present invention will be described.

The standard location information generation method uses a URL on which a media resource is provided, or uses the URL, track information of an MPEG-4 file, and an ESID and an OSID of the MPEG-4 file to generate standard location information when the media resource to be referred to is an MPEG-21 file.

For example, when attempting to refer to a video file (test.avi) at a specific site of ‘www.etri.re.kr’, the URL on which the video file is provided is used to generate standard location information as follows.

<Resource
target=“http://www.etri.re.kr/test.avi”mimeType=“video/avi”>

Also, when attempting to externally refer to an ES indicated by the first track value of track[1] of the MPEG-4 file of ‘test.mp4’ in the site of ‘www.etri.re.kr’, track information which indicates the URL on which the MPEG-4 file is provided and the ES is used to generate the standard location information as follows.

<Resource
target=http://www.etri.re.kr/test.mp4:moov/track[1]”mime
Type=“video/mp4”>

In this instance, it is possible to show that the file to be referred to is the MPEG-4 file, by adding the special symbol of ‘/’ other than the moov.

Also, when attempting to externally refer to an ES shown by a medium provided on the first track in the MPEG-4 file, the URL on which the MPEG-4 file is provided, the track information for indicating the ES, and media information are used to generate the standard location information as follows.

<Resource
target=http://www.etri.re.kr/test.mp4:moov/track[1]/media ”mime
Type=“video/mp4”>

In this instance, the moov can be replaced by the special symbols of ‘/.’

Further, when attempting to refer to the ES which has a predetermined ODID and ESID in the MPEG-4 file, the standard location information can be generated by combination of the URL on which the MPEG-4 file is provided and the ODID and ESID of the ES.

<Resource target=“
http://www.etri.re.kr/test.mp4:odid=0x10&esid=0x11”>

That is, when the value of ODID is 0x10 and the value of ESID is 0x11, the addressing is performed by using the values of ODID and ESID of the URL and the MPEG-4 file.

In addition, when attempting to refer to the MPEG-4 file stored at a specific location in the external MPEG-21 file, the standard location information including a URL of the site having the MPEg-21 file, an offset value of the media data box 120 storing the MPEG-4 file, and combination of the ODID and ESID of the MPEG-4 file is generated.

For example, the standard location information is generated is the subsequent format when referring to the media resource having the values of ODID=0x10 and ESID=0x11 from among various ESs which configure the MPEG-4 file in which the offset value in the external ‘test.mp21’ is stored in the location of 1000.

<Resource ref=
“http://www.etri.re.kr/test.mp21#offset=1000:odid=0x10&esid=0x11”>

As described above, various media resources provided in the external MPEG-21 file are referred to.

The standard location information generating method has been described according to the preferred embodiment of the present invention. Standard location information of media resource is stored in the item location region of the meta data box 110, and in this instance, the item location region can be defined by the syntax and semantics to be described later.

Syntax of the item location region according to the preferred embodiment of the present invention is described below.

Item Location Box Syntax

```
    aligned(8) class ItemLocationBox extends FullBox(‘iloc’, version =
0, 0) {
    unsigned int(4)offset_size;
    unsigned int(4)length_size;
    unsigned int(4)base_offset_size;
    unsigned int(1)reference_type
    unsigned int(3)reserved
    unsigned int(16)  item-count;
    for(i=0;i<item-count;i++)
    {
    unsigned int(16)  Item-ID
    unsigned int(16)  data-reference-index;
      if(reference_type ==0)
      {
      offset;
      length;
      base_offset;
      }
      if(reference_type == 1)
        offset;
    String location;
    }
    }
```

Also, syntax of the item location region according to the second preferred embodiment of the present invention is described below.

```
    aligned(8) class ItemLocationBox extends FullBox(‘iloc’, version =
0, 0) {
    unsigned int(4)offset_size;
    unsigned int(4)length_size;
    unsigned int(4)base_offset_size;
    unsigned int(1)reference_type
    unsigned int(3)reserved
    unsigned int(16)  item-count;
    for(i=0;i<item-count;i++)
    {
    Item-ID
    data-reference-index
    Stringlocation
    direct-offset
      if(direct-offset == 1)
      {
      offset;
      length
      base_offset;
      }
    }
    }
```

Semantics of the item location region according to the preferred embodiment of the present invention are described below.

Item Location Box semantics

offset_size is taken from the set {0, 4, 8} and indicates the length in bytes of the offset field.

length_size is taken from the set {0, 4, 8} and indicates the length in bytes of the length field.

item-count counts the number of items in the following array.

Item-ID is an arbitrary integer ‘name’ for this item which can be used to refer to it (e.g. in a URL).

data-reference-index is either zero (‘this file’) or a 1-based index into the data references in the data information box.

offset provides the absolute offset in bytes from the beginning of the containing file, of this meta-data item. If offset_size is 0, offset takes the value 0.

length provides the absolute length in bytes of this meta-data item. If length_size is 0, length takes the value 0. If the value is 0, then length of the item is the length of the entire referenced file.

base_offset provides a base value for offset calculations within the referenced data. If base_offset_size is 0, base_offset takes the value 0, i.e. it is unused.

reference_type specifies the type of referenced item. If this value is 1, then the referenced media resource is an ES in mp4 presentation.

Location specifies the information of which ES within a mp4 presentation is referenced. In the case that an ES in the first track in mp4 presentation is referenced, string value, “moov/trak[1]” or “//trak[1]”, will be defined. In addition, an ES can be referenced with odid and esid (e.g. odid=0x10&esid=0x11).

Further, when data-reference-index is given to be 0, URL/URN information of the media resource to be externally referred to is defined by strings in the data information region (dataInformationBox), and the syntax and semantics of the data information region in this instance are defined below.

Data Information Box Syntax

(1) aligned(8) class DataEntryUrlBox (bit(24) flags)
extends FullBox(‘url ’, version = 0, flags) {
stringlocation;
}
(2) aligned(8) class DataEntryUrnBox (bit(24) flags)
extends FullBox(‘urn ’, version = 0, flags) {
string name;
string location;
}
(3) aligned(8) class DataReferenceBox
extends FullBox(‘dref’, version = 0, 0) {
unsigned int(32) entry_count;
for (i=1; i = entry_count; i++) {
DataEntryBox(entry_version, entry_flags) data_entry;
}
}

Data Information Box Semantics

version is an integer that specifies the version of this box.

entry_count is an integer that counts the actual entries.

entry_version is an integer that specifies the version of the entry format.

entry_flags is a 24-bit integer with flags; one flag is defined (x000001) which means that the media data is in the same file as the Movie Box containing this data reference.

data_entry is a URL or URN entry. Name is a URN, and is required in a URN entry. Location is a URL, and is required in a URL entry and optional in a URN entry, where it gives a location to find the resource with the given name. Each is a null-terminated string using UTF-8 characters. If the self-contained flag is set, the URL form is used and no string is present; the box terminates with the entry-flags field. The URL type should be of a service that delivers a file (e.g. URLs of type file, http, ftp, etc.), and which services ideally also permit random access. Relative URLs are permissible and are relative to the file containing the Movie Box that contains this data reference.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

Also, the method of using the URL having the media resource when the media resource is externally referred to has been described, which represents the location where the media resource is provided, thereby allowing the URN to be used as a digital contents identification system, and the URL according to the present invention includes URN and other identification systems.

1. In a method for addressing a media resource for a media file including a meta data box including a DID (digital item declaration) and a media data box, a media resource addressing method comprising:
extracting a corresponding media resource according to reference information of the media resource recorded in the DID;
storing the extracted media resource in the media data box;
generating standard location information of the media resource;
storing the generated standard location information in the meta data box; and
filing the meta data box and the media data box.

2. The media resource addressing method of claim 1, wherein the standard location information of the media resource is generated by using an offset value of the media data box storing the media resource.

3. The media resource addressing method of claim 1, wherein the standard location information is generated by using an offset value of an MPEG (motion picture experts group)-4 file stored in the media data box and location information of the media resource of the MPEG-4 file when the media resource is provided in the MPEG-4 file.

4. The media resource addressing method of claim 3, wherein location information of the media resource provided in the MPEG-4 file is a track value provided in the meta data box of the MPEG-4 file.

5. The media resource addressing method of claim 3, wherein location information of the media resource provided in the MPEG-4 file includes an ODID (object descriptor ID) and an ESID (elementary stream ID) of the media resource.

6. The media resource addressing method of claim 1, wherein the meta data box further comprises a local item region, and the standard location information is stored in the local item region.

7. The media resource addressing method of claim 1, wherein the media file is an MPEG-21 file.

8. In a method for addressing a media resource for a meta data box including a DID (digital item declaration) and a media file including a media data box, a media resource addressing method comprising:
reading reference information of a media resource recorded in the DID;
reading reference information of the media resource of a second media file when the media resource is provided in the second media file;
using the reference information of the media resource and the reference information of the second media file, and generating standard location information;
storing the standard location information in the meta data box; and
filing the meta data box.

9. The media resource addressing method of claim 8, wherein the standard location information is formed including a URL (uniform resource protocol) at which an MPEG (motion picture experts group)-4 file is provided and combination of track values for indicating the media resource in the MPEG-4 file, when the second media file is an MPEG-4 file.

10. The media resource addressing method of claim 8, wherein the standard location information is formed including a URL (uniform resource protocol) at which an MPEG (motion picture experts group)-4 file is provided and combination of an ODID and an ESID of the media resource, when the second media file is an MPEG-4 file.

11. The media resource addressing method of claim 8, wherein the standard location information is formed including a URL (uniform resource protocol) at which an MPEG (motion picture experts group)-21 file is provided and combination of offset values of a region in which the media resource is stored from among the media data box of the MPEG-21 file, when the second media file is an MPEG-21 file.

12. The media resource addressing method of claim 8, wherein the standard location information is formed including a URL (uniform resource protocol) at which an MPEG (motion picture experts group)-21 file is provided, a combination of offset values of a region in which the MPEG-4 file is stored from among the media data box of the MPEG-21 file, and a combination of track values for indicating the media resource in the MPEG-4 file, when the second media file is an MPEG-21 file and the media resource is an MPEG-4 file provided in the media data box of the MPEG-21 file.

13. The media resource addressing method of claim 8, wherein the standard location information is formed including a URL (uniform resource protocol) at which an MPEG (motion picture experts group)-21 file is provided, a combination of offset values of a region in which the MPEG-4 file is stored from among the media data box of the MPEG-21 file, and a combination of an ODID and an ESID of the media resource, when the second media file is an MPEG-21 file and the media resource is an MPEG-4 file provided in the media data box of the MPEG-21 file.

14. In a media resource addressing device for an MPEG (motion picture experts group)-21 file including a meta data box including a DID and a media data box, a media resource addressing device comprising:
a DID reader for reading reference information of the media resource recorded in the DID, determining whether the DID refers to the media resource in the file or out of the file, and outputting the reference information of the media resource when the DID refers to the media resource in the file;
a media resource extractor for extracting the media resource according to the reference information output by the DID reader, and storing the media resource in the media data box;
a standard location generator for generating standard location information of the media resource, and storing the standard location information in the meta data box; and
a filing unit for filing the meta data box and the media data box into a single file.

15. In a recording medium for writing a media resource addressing program of an MPEG-21 file including a meta data box including a DID (digital item declaration) and a media data box, a recording medium for writing a media resource addressing program comprising:
reading media resource reference information recorded in the DID; extracting the media resource, storing the extracted media resource in the media data box, using an offset value of the media data box storing the media resource, and generating standard location information of the media resource when the DID refers to the media resource in the file; and
using location information of the media resource, and generating standard location information of the media resource when the DID refers to the media resource out of the file.

16. The recording medium of claim 15, wherein the media resource addressing program further comprises: reading information for referring to the media resource from a second media file, and generating the standard location information by combining location information of the second media file and location information of the media resource defined by the second media file, when the DID refers to the media resource out of the file and the media resource is included in the second media file.
